(19) United States
(12) Patent Application Publication
(10) Pub. No.: US 2006/0128815 A1
(43) Pub. Date: Jun. 15, 2006

(54) Method for controlling droplet size of an emulsion when mixing two immiscible fluids

(76) Inventors: Hugh John Clare, Formby (GB); Christopher Anthony Pearson, Harpenden (GB); Ian Alexander Shanks, Broughty Ferry (GB)

Correspondence Address: UNILEVER INTELLECTUAL PROPERTY GROUP, 700 SYLVAN AVENUE,, BLDG C2 SOUTH, ENGLEWOOD CLIFFS, NJ, 07632-3100, US

(21) Appl. No.: 10/529,618

(22) PCT Filed: Aug. 29, 2003
(86) PCT No.: PCT/EP03/09665

§ 371 Date: Sep. 12, 2005

(30) Foreign Application Priority Data
Oct. 2, 2002 (EP) 0226859.6

(51) Int. Cl. B01F 17/00

(52) U.S. Cl. 516/9

(57) ABSTRACT

The invention relates to a method for preparing an emulsion by membrane emulsification enabling control of the dispersed phase size and size distribution by interrupting extrusion of the dispersed phase.

### FIELD OF THE INVENTION

The invention relates to a method for controlling droplet size during emulsification of two fluids by driving a discrete liquid phase into a continuous liquid phase, for example using membrane emulsification techniques.

### BACKGROUND OF THE INVENTION

Mixing of two immiscible liquids generally leads to the formation of a dispersed phase and a continuous phase. A well known example of such a mixing process is emulsification. In this application the term emulsification refers to mixing of two immiscible fluids resulting in a dispersed phase and a continuous phase. An example is emulsification of water and oil. The properties of emulsions may depend on their dispersed phase droplet size and size distribution. Control of droplet size and size distribution have been addressed in the art.

U.S. Pat. No. 3,278,165 discloses that a vibrating element may be used as a means for effecting dispersion or emulsification. This processing principle does not lead to a particularly small dispersity nor adjustment or tuning of the droplet size.

The production of oil and water containing emulsions using membranes is known from several publications. The art, e.g. Suzuki et al, Food science technol. Int. Tokyo, 2 (1), 43-47, 1996, suggests that this technique has been applied successfully. Initial work used sintered microporous glass membranes. More recently different materials have been fabricated using laser ablation techniques. The alleged advantages of the membrane emulsification technique compared to conventional emulsification by e.g. turbulent shear are that droplet size and distribution are more controllable, products may be made more reproducible, low energy requirement compared to conventional techniques.

WO-A-97/36674 discloses a method for preparing an emulsion wherein a discontinuous phase is introduced into a circulating continuous phase through a membrane, which is characterised by at least one of the following features:

a) it consists of ceramic or sintered material

b) it is formed in a plurality of segments which may be identical or different from each other

c) at least one segment is tubular in shape and divergent in diameter along the length of the tube.

Furthermore JP 2-214537 discloses a method of preparing emulsions wherein the aqueous phase is passed under pressure through the pores of a membrane into an oil phase containing a surfactant, the membrane being subjected to ultrasonic radiation (frequency of at least 20 kHz) during the process. U.S. Pat. No. 3,809,372 refers to the use of ultrasonics to create emulsions through a membrane. Emulsions prepared this way show quite a wide range of droplet sizes and it was found merely impossible to tune the droplet size. Furthermore input of ultrasonics into a membrane may lead to technical difficulties because of fluid damping.

DE-A-4304260 discloses pulsated extrusion of a dispersed phase into a continuous phase. The actuation is not set individually for each hole of the membrane but controlled by the displacement of the membrane in a first chamber. This method only offers limited control over the droplet size and size distribution.

DE-A-952707 also discloses the introduction of an ultrasonic element as an energy component in the continuous phase to break down the discontinuous phase into droplets. This method offers limited control, if any, over the droplet size formation and distribution of droplet sizes.

There are several further disadvantages to the known techniques wherein membrane emulsification is used. Firstly the emulsions formed do not have controllable monodispersity. Secondly the scale up of these systems is difficult. We have found that for many liquid/liquid membrane systems only a few holes are operative which reduces efficiency considerably.

Furthermore the ultrasonic system requires very high-energy input which may lead to local negative impacts on the products involved, e.g. due to local heating. Also the use of ultrasonics makes the method complicated and expensive.

It is an object of the invention to provide a method of membrane emulsification enabling control of the droplet size accurately. A further object is to prepare monodisperse emulsions with droplets of pre-determined size. Another object is to provide a method, which is efficient and easily scaled up.

### SUMMARY OF THE INVENTION

It has surprisingly been found that interruption of the extrusion of the dispersed phase fluid enables control of the droplet size and droplet size distribution of the final product.

Therefore the invention relates to a method for preparing a dispersion of one fluid in another fluid by extruding one fluid, which is the dispersed phase, through a membrane orifice into another fluid which is the continuous phase, wherein the extrusion is interrupted prior to, during or after the dispersed fluid has emerged from the orifice.

In a further aspect the invention relates to the use of this method to prepare an oil and water containing emulsion.

### DETAILED DESCRIPTION OF THE INVENTION

In the context of the invention, the terms “fat” and “oil” are used interchangeably. The term oil encompasses both triglyceride oils and diglyceride oils.

For the purpose of the current invention, wt % is defined as weight percent on total product weight unless otherwise is indicated.

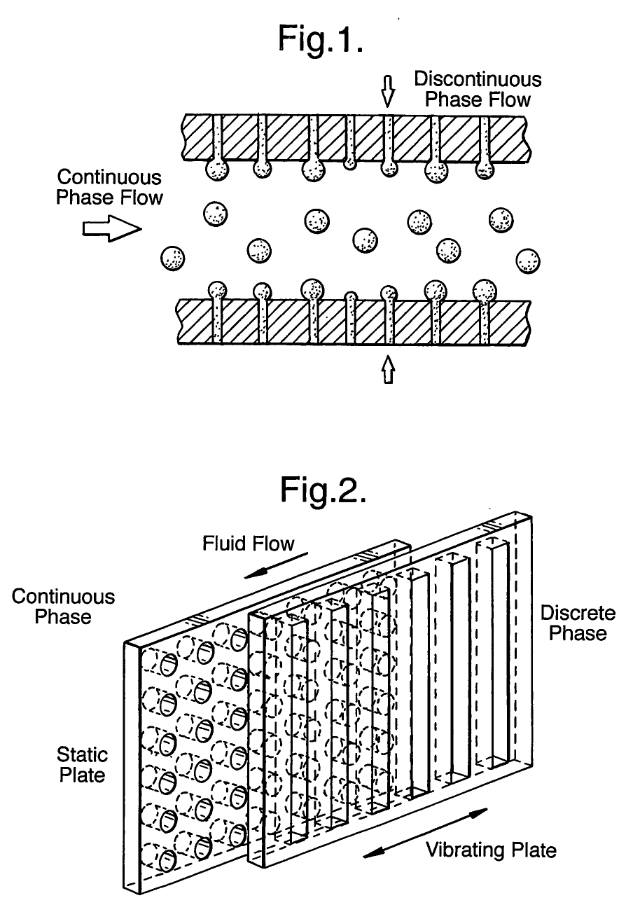

FIG. 1 illustrates the principle of cross flow membrane emulsification.

The dispersed phase is extruded through a hole or many holes which constitute a membrane. The membrane itself comprises one hole or a plurality of holes, which may be identical or different in shape of the orifices. It is preferred that the orifice is circular. Furthermore it is preferred that the membrane comprises a plurality of holes.

The membrane is made out of any suitable material. A membrane made with holes of a consistent geometry and spacing is highly preferred. Ceramic materials may be used. Alternatively the membrane is based on a silicon chip.

The geometric configuration of the membrane will vary depending on the application or set up in which it's use is envisaged. The membrane may be tubular in shape where the continuous phase flows through the inner side of the tube. Alternatively the membrane is placed flat with the continuous phase flowing at one side of the membrane. Dead-end emulsification may be used. Also, the flow of the continuous phase does not necessarily have to be parallel with the surface containing the hole(s). In a preferred embodiment, the membrane is operated under cross flow of the continuous phase.

The extrusion of the dispersed phase into the continuous phase through an orifice is interrupted prior to, during or after the dispersed fluid has emerged from the orifice. This interruption was found to lead to the formation of droplets showing a consistent and controllable size distribution. It is already known that droplet size can be varied by changing the speed of the continuous phase moving past the orifice from which the discrete phase emerges. However, the interrupted extrusion method according to the invention allows the size of the droplets to be altered by varying the frequency of the interruption. Thus for one fixed geometry of the flow regime, droplet size can be “tuned” using a combination of continuous liquid phase speed, and the frequency of vibration of the interruption.

The interruption in extrusion may be obtained in many ways. It is preferred that the interruption of flow is caused by a disturbance in the flow of the continuous fluid or energy input into the dispersed fluid. The use of ultrasound to put energy into the dispersed fluid is not encompassed within the invention because of the above mentioned disadvantages of ultrasound. Also ultrasound is difficult to control and hence the resulting emulsions lack a controlled and consistent droplet size distribution for the dispersed phase.

For the purpose of the invention interruption is defined as an essentially complete stop of the dispersed phase flowing through the orifice. An essentially complete stop is a stop of at least 90% of the original flow of the dispersed phase, more preferred from 95 to 100%, most preferred an entire stop of the dispersed phase flowing through the orifice.

According to a preferred embodiment, the interruption of extrusion is caused by a disturbance in flow of the continuous fluid. This disturbance in flow may be obtained by a variety of measures. We have found that by simple vibration of a wire or plate which is placed at a short distance from an orifice, the droplet size and size distribution can easily be controlled. FIG. 2 shows the embodiment wherein a plate is used.

Therefore it is preferred that the flow in the continuous fluid is disturbed by a vibrating wire or plate which is placed at a distance of less than 1 mm, preferably from 0.1 to 0.5 μm from the orifice through which the dispersed phase is extruded.

The wire or plate, are positioned such that they can still interact with the forming dispersed phase droplet. If a wire is used, the wire is preferably placed such that it crosses the centre of the orifice while it is positioned parallel to the membrane. It will be appreciated that for a membrane comprising a plurality of lanes of orifices, a matching multitude of wires may be used.

If a plate is used, it is preferably positioned parallel to the membrane.

The wire or plate disturbs the extrusion by vibrating at a specific frequency. Surprisingly this frequency need not be high frequency such as ultrasound. It is preferred that the vibration frequency of the wire or plate is from 0.1 to 2 kHz, preferably from 1 to 1.8 kHz. Higher frequencies may be used.

We have found that the droplet size of the dispersed phase may be controlled by the frequency of vibration of the wire or plate. The droplet size is reduced by increasing the vibration frequency. As indicated above, the droplet size of the dispersed phase may further be controlled by the speed of the cross flow of the continuous phase. The size of the droplets is reduced by increasing the flow speed of the continuous phase.

Optionally a multitude of wires is used whereby different vibration frequencies are applied to different wires.

According to another embodiment, in stead of a wire a comb type of structure is placed and vibrated near the membrane orifices.

A further way to control droplet size of the dispersed phase is via the diameter of the membrane orifices. Preferably a membrane orifice has a diameter of from 0.1 to 120 μm, more preferably from 0.2 to 8 μm.

Yet another way to control droplet size is the geometry of the exit of the orifice, and also whether the surface of the membrane is hydrophobic or hydrophillic.

In a preferred embodiment, the interruption is created using means that are applied locally next to the orifice. According to a further preferred embodiment the means are applied locally and preferably individually for each orifice.

We have found that this method is highly suitable for use in a microsystem. Therefore in a preferred embodiment the invention relates to a method wherein the disturbance in the flow or energy transfer is generated with microengineered electromechanical devices.

The method is applicable for the preparation of mixtures of immiscible fluids. Preferably the fluids mixed are oil and water whereby each can serve as dispersed or continuous fluid. Both the continuous fluid and the dispersed fluids may themselves be mixtures of fluids or emulsions from the start.

It is preferred that the continuous phase fluid is water. It is also preferred that the dispersed phase fluid is oil.

In a preferred embodiment one of the two fluids comprises a surfactant such as Tween™, mono/di-glyceride fatty acid esters, Span™, lecithin or a combination thereof.

In a further aspect the invention relates to the use of a method according to the invention for the preparation of an oil and water containing emulsion. Such emulsions are e.g. applied in food products, skin care products, shampoos and the like.

Examples of food products are sauces, fresh cheese, mayonnaise, spreadable products, dressings. Examples of skin care products are creams, lotions.

The invention is illustrated in the following non-limiting examples.

### EXAMPLES

A single orifice silicon chip, featuring a gold wire shutter was designed and fabricated at DERA, Malvern. The pore size was 5 μm in diameter straddled by a 5 μm diameter gold wire. The chip was mounted in a clear plastic housing enabling cross flow of a continuous phase passed the orifice on the same side of the chip as the vibrating gold wire. The gold wire was linked to two electrodes, to a 5 MHz pulse/function generator and an oscilloscope, and was oscillated at a frequency of approximately 0 to 1.5 kHz. The continuous phase was water, and oil was driven through the orifice into the water stream using a syringe pump. The gold wire lay in the direction of the flow. Experiments were carried out under the following conditions:

a) oil phase: low viscosity mineral oil

b) Oil phase flow rate: 2.218 cm3/hour, (6.16×10-10 m3/s)

c) Continuous phase: water plus 2% Tween20

d) Continuous phase flow rate: 8 mm/s

When the gold wire was vibrated (according to the invention), the effect was instantaneous, with the droplet size showing very consistent size distribution, having a mean diameter of 36 μm and a standard deviation of 2.31.

When the vibration was turned off (0 Hz, not according to the invention)it was found that the single orifice with the gold wire static produced droplets having a diameter of about 60 μm.

1. A method for preparing a dispersion of one fluid in another fluid by extruding one fluid, which is the dispersed phase, through a membrane orifice into another fluid which is the continuous phase, characterised in that the extrusion is interrupted prior to, during or after the dispersed fluid has emerged from the orifice.

2. A method according to claim 1 wherein the interruption of flow is caused by a disturbance in the flow of the continuous fluid or energy input into the dispersed fluid.

3. A method according to claim 1 wherein the interruption of extrusion is caused by a disturbance in flow of the continuous fluid.

4. A method according to claim 3 wherein the flow in the continuous fluid is disturbed by a vibrating wire or plate which is placed at a distance of less than 1 mm from the membrane orifice through which the dispersed phase is extruded.

5. A method according to claim 4 wherein the wire or plate vibrates at a frequency of 0.1 to 2 kHz, preferably from 1 to 1.8 kHz.

6. A method according to any of claims 1-5 wherein the membrane orifice has a diameter of from 0.1 to 120 μm, preferably from 0.2 to 8 μm.

7. A method according to any of claims 1-6 wherein the disturbance in the flow or energy transfer is generated with microengineered electromechanical devices.

8. A method according to any of claims 1-7 wherein the membrane is operated under cross flow of the continuous phase.

9. Use of a method according to any of claims 1-8 for the preparation of an oil and water containing emulsion.
